(19) United States
(12) Patent Application Publication
(10) Pub. No.: US 2025/0323298 A1
(43) Pub. Date: Oct. 16, 2025

(54) METHANE-OXYGEN BATTERY SYSTEM AND METHOD OF USE THEREOF

(71) Applicant: Form Energy, Inc., Somerville, MA (US)

(72) Inventors: Joseph S. Manser, Reading, MA (US); Christopher Thomas Reynolds, Arlington, MA (US); Liang Su, Medfield, MA (US); Nicholas Perkins, Emeryville, CA (US)

(21) Appl. No.: 19/175,341

(22) Filed: Apr. 10, 2025

Related U.S. Application Data
(60) Provisional application No. 63/632,416, filed on Apr. 10, 2024.

(51) Int. Cl. H01M 8/0612; H01M 8/04007; H01M 8/04089; H01M 8/0444; H01M 8/2457

(52) U.S. Cl. CPC H01M 8/0631; H01M 8/04007; H01M 8/04104; H01M 8/0444; H01M 8/2457

(57) ABSTRACT

A methane-oxygen battery system including an electrochemical cell including a positive electrode, a negative electrode, and an electrolyte; a reactor in fluid communication with the negative electrode; a fuel gauge; and a gas store including a first compartment in fluid communication with the positive electrode and configured to store oxygen, a second compartment in fluid communication with the negative electrode and configured to store carbon dioxide and water, a third compartment in fluid communication with the negative electrode or the reactor and configured to store methane, a first barrier between the first compartment and the second compartment, and a second barrier between the second compartment and the third compartment. The gas store and the electrochemical cell form a closed system. The fuel gauge is configured to determine a state of charge based on a position of at least one of the first barrier or the second barrier.

### CROSS REFERENCE TO RELATED APPLICATION

This application claims priority to and the benefit of U.S. Provisional Patent Application No. 63/632,416, filed Apr. 10, 2024, in the United States Patent and Trademark Office, the content of which in its entirety is hereby incorporated by reference.

### BACKGROUND

This disclosure relates to a methane-oxygen battery, a method of use thereof, and a fuel gauge of the methane-oxygen battery.

Rechargeable batteries are electrochemical devices that can deliver electricity on discharge and can be charged to store electricity. Rechargeable batteries help solve the problem of discontinuous production of electrical energy and allow for storing electrical energy when the electricity supply does not match the electricity demand.

Reversible fuel cells use stored chemical reactants in an energy storage mode, where the chemical reactants are continuously supplied from an external source to the cell, and the products stored outside the system. The reactants and products are charge-neutral species, such as carbon dioxide and water as reactants and methane and oxygen as products, in the energy storage mode. A reversible fuel cell that is operated as a closed system may be considered as a type of flow battery. The storage tanks can also be configured for continuous flow to an external source or storage, i.e., corresponding to a flow battery with infinite capacity.

There remains a continuing need for rechargeable batteries and reversible fuel cells, and in particular, methods for determining the state of charge (SOC) in these systems.

### SUMMARY

Provided is a methane-oxygen battery system including an electrochemical cell including a positive electrode, a negative electrode, and an electrolyte between the positive electrode and the negative electrode; a reactor in fluid communication with the negative electrode; a fuel gauge; and a gas store including a first compartment in fluid communication with the positive electrode and configured to store oxygen, a second compartment in fluid communication with the negative electrode and configured to store carbon dioxide and water, a third compartment in fluid communication with the negative electrode or the reactor and configured to store methane, a first barrier between the first compartment and the second compartment, and a second barrier between the second compartment and the third compartment. The gas store and the electrochemical cell form a closed system. The fuel gauge is configured to determine a state of charge based on a position of at least one of the first barrier or the second barrier.

Also disclosed is a methane-oxygen battery system, comprising: an electrochemical cell comprising a positive electrode, a negative electrode, and an electrolyte between the positive electrode and the negative electrode; a reactor in fluid communication with the negative electrode; a fuel gauge; and a gas store comprising a first compartment in fluid communication with the positive electrode and configured to store oxygen, a second compartment in fluid communication with the negative electrode and configured to store carbon dioxide and water, a third compartment in fluid communication with the negative electrode and configured to store methane, a first barrier between the first compartment and the second compartment, and a second barrier between the second compartment and the third compartment. The gas store and the electrochemical cell form a closed system. The fuel gauge is configured to determine a state of charge based on a mass of a gas in the gas store, wherein the mass of gas the gas store comprises a mass of oxygen in the first compartment, a mass of carbon dioxide and water in the second compartment, a mass of methane in the third compartment, or a combination thereof.

Also disclosed is a methane-oxygen battery system, comprising: an electrochemical cell comprising a positive electrode, a negative electrode, and an electrolyte between the positive electrode and the negative electrode; a reactor in fluid communication with the negative electrode; a fuel gauge configured to determine a state of charge; a gas inlet in fluid communication with the positive electrode and configured to provide oxygen on discharge of the system, a fuel inlet in fluid communication with the negative electrode or the reactor and configured to provide methane on discharge of the system, and an exhaust gas outlet in fluid communication with the negative electrode and configured to exhaust carbon dioxide and water on discharge of the system.

Also disclosed is a battery fuel gauge configured to determine a state of charge of a methane-oxygen battery, wherein the battery fuel gauge comprises a processor configured to receive information relating to a position of a first barrier and/or a position of a second barrier of a gas store and to determine the state of charge based on the position of the first barrier and/or the position of the second barrier; wherein the methane-oxygen battery comprises: an electrochemical cell comprising a positive electrode, a negative electrode, and an electrolyte between the positive electrode and the negative electrode; a reactor in fluid communication with the negative electrode; and the gas store comprising a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, the first barrier between the first compartment and the second compartment, and the second barrier between the second compartment and the third compartment, wherein the gas store and the electrochemical cell form a closed system.

Also disclosed is a battery fuel gauge configured to determine a state of charge of a methane-oxygen battery, wherein the battery fuel gauge comprises a processor configured to receive information relating to a mass of a gas in a gas store, wherein the mass of the gas in the gas store comprises a mass of oxygen in a first compartment, a mass of carbon dioxide and water in a second compartment, a mass of methane in a third compartment, or a combination thereof, and to determine the state of charge based on the mass of the gas in the gas store; wherein the methane-oxygen battery comprises: an electrochemical cell comprising a positive electrode, a negative electrode, and an electrolyte between the positive electrode and the negative electrode; a reactor in fluid communication with the negative electrode; and the gas store comprising the first compartment in fluid communication with the positive electrode and configured to store oxygen, the second compartment in fluid communication with the negative electrode and configured to store carbon dioxide and water, the third compartment in fluid communication with the negative electrode and configured to store methane, a first barrier between the first compartment and the second compartment, and a second barrier between the second compartment and the third compartment, wherein the gas store and the electrochemical cell form a closed system.

Also disclosed is a method of operating a methane-oxygen battery system, the method comprising: providing the methane-oxygen battery system; supplying electricity, carbon dioxide, and water to the electrochemical cell to charge the battery system, wherein hydrogen and carbon monoxide are converted in the reactor to methane and water, carbon dioxide and water are converted to carbon monoxide, hydrogen, and oxygen by the electrochemical cell, and the carbon dioxide and a portion of the water are provided by the gas store, and oxygen and methane are stored in the gas store; and discharging the methane-oxygen battery system to convert carbon monoxide, hydrogen, and oxygen to carbon dioxide and water, and produce electricity to operate the methane-oxygen battery system, wherein methane and water are converted in the reactor to hydrogen and carbon monoxide, carbon monoxide, hydrogen, and oxygen are converted to carbon dioxide and water by the electrochemical cell, the carbon dioxide and a portion of the water produced by the electrochemical reactor are stored in the gas store, and the methane is provided by the gas store.

Also disclosed is a method of operating a methane-oxygen battery system, the method comprising: providing the methane-oxygen battery system; supplying electricity, carbon dioxide, and water to the electrochemical cell to charge the battery system, wherein the carbon dioxide and a portion of the water are provided by the exhaust gas outlet, the carbon dioxide and the water are converted to carbon monoxide, hydrogen, and oxygen by the electrochemical cell, and the hydrogen and the carbon monoxide are converted to methane and water by the reactor; and discharging the methane-oxygen battery system to convert carbon monoxide, hydrogen, and oxygen to carbon dioxide and water, and produce electricity to operate the methane-oxygen battery, wherein the methane is provided by the fuel inlet, the oxygen is provided by the gas inlet, the methane and the water are converted to hydrogen and carbon monoxide by the reactor, the carbon monoxide, the hydrogen, and the oxygen are converted to carbon dioxide and water by the electrochemical cell, and the carbon dioxide and a portion of the water produced by the electrochemical reactor are exhausted by the exhaust gas outlet.

### BRIEF DESCRIPTION OF THE DRAWINGS

The following figures are exemplary embodiments wherein like elements are numbered alike.

FIG. 1 is a schematic diagram of a methane-oxygen battery system employing passive flow according to one or more aspects;

FIG. 2 is a schematic diagram of the methane-oxygen battery system employing passive flow according to one or more aspects;

FIG. 3 is a schematic diagram illustrating an electrochemical cell according to one or more aspects;

FIG. 4 is a schematic diagram illustrating a methane-oxygen battery system according to one or more aspects; and

FIG. 5 is a schematic diagram illustrating a methane-oxygen battery system according to one or more aspects.

### DETAILED DESCRIPTION

Methane-oxygen battery systems include an electrochemical cell that converts methane and oxygen to carbon dioxide and water on discharge, or carbon dioxide and water to methane and oxygen on charge. The battery system includes a reactor, such as a reactor that converts methane and water to carbon monoxide and hydrogen on discharge, or converts carbon monoxide and hydrogen to methane and water on charge. The net reaction for the methane-oxygen battery system is shown in equation (1):

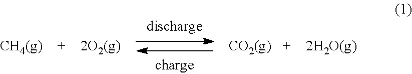

During discharge of the methane-oxygen battery system, O₂ is converted to O₂⁻ at the positive electrode according to equation (2), and on charge the reaction is reversed:

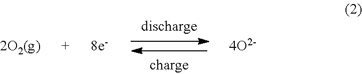

During discharge of the methane-oxygen battery system, carbon monoxide, hydrogen, and O₂⁻ are converted to carbon dioxide and water at the negative electrode according to equation (3), and on charge the reaction is reversed:

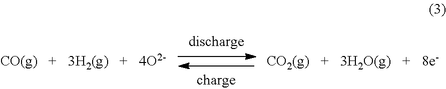

Energy storage systems with decoupled energy and power in which electrochemical reactants and products are stored separately from the electrode surfaces and in which the concentration of reactants entering the stack and pressure of operation within the stack are relatively constant cannot readily rely on electrochemical measurements such as voltage, resistance, or derivative quantities of these factors to estimate state of charge. In such systems, the electrochemical potential and electronic and mass transport properties at the positive and negative electrodes remain relatively constant as the energy storage medium is depleted and replenished. Therefore, alternative methods for accurate fuel gauging are required.

The present disclosure provides fuel gauging for a passive flow battery or a reversible fuel cell system. In an active flow battery or in a reversible fuel cell system, fluid communication between the stored electrochemical reactants and/or products and the power stack can be provided by a series of balance-of-plant (BOP) components, such as pipes, tubes, manifolds, pumps, compressors, expanders, and/or recirculators. The pumps, recirculators, compressors, and related components are “active” components in the sense that they consume power in order to convey reactants and products to and from the power stack, resulting in parasitic power consumption. This parasitic power consumption decreases the net output power from the system during discharge and increases the net input power required during charge, reducing the efficiency of the system and increasing operating costs. These active components and their associated hardware also add capital cost to the system without directly participating in electrochemical conversion reactions. As such, they are considered part of the BOP of the system. BOP can be a significant capital cost driver, representing in some applications more than 60% of the total installed cost. BOP components may also reduce the power and energy density of the system by taking up volume without directly contributing to power generation and energy conversion.

U.S. Pat. No. 8,637,197, the content of which is incorporated herein by reference in its entirety, describes a methane-oxygen flow system for electrical energy storage based on a reversible solid oxide fuel cell, wherein CO₂ and H₂O are electrochemically converted into electrochemical products of primarily methane, hydrogen and gaseous oxygen in a charge mode. The reactants and products are gaseous and are stored as gases, with the exception of H₂O, which may be stored as liquid water. The net reaction may occur in one or more steps. Although the reactants and products are low cost chemicals, the system requires a significant set of balance-of-system components including flow and pressure controlling means.

Disclosed is an alternative system design in which conveyance of electrochemical reactants and products to and from the power stack may be achieved through “passive” means. Such a passive system requires few to no BOP components for conveyance of reactants and products to and from the power stack. Passive flow systems therefore have the potential for higher efficiency, higher power density, and lower cost relative to active flow systems. Passive flow in self-contained, closed systems such as flow batteries and reversible fuel cells can be achieved through judicious control of electrochemical and chemical reactant and product stoichiometry and phase. As used herein, a “closed system” means that internal changes in pressure, temperature, and/or concentration occurring any place within the system may generate a gas flow within the closed system so that the components of the system are pressure-balanced.

Disclosed herein is a methane-oxygen battery system. In some aspects, the methane-oxygen battery system may be configured to estimate the energy remaining in the battery system at a given time. For example, monitoring the energy remaining in the battery system can enable estimation of the remaining runtime if the battery is discharged, or the remaining energy which may be added into the system on charge. Estimating the energy in the system is often referred to as “fuel gauging” in the art, and may also be known as “state-of-charge estimation,” or “SOC estimation,” and similarly “state of energy estimation,” or “SOE estimation.” In some aspects, the methane-oxygen battery system can alternatively or additionally include field replaceable electrochemical cells. Field replaceable cells can accommodate component replacement in a fielded system without the need for additional installation/de-installation, shipping, and transport of an entire system. Method of use of the methane-oxygen battery system, including estimating remaining energy and isolating and replacing battery components, e.g., an electrochemical cell, during continued operation of the battery system are described herein.

An aspect provides a methane-oxygen battery system that includes an electrochemical cell, a reactor, a gas store, and a fuel gauge. The electrochemical cell includes a positive electrode, a negative electrode, and an electrolyte between the positive electrode and the negative electrode. The reactor, which may be a catalytic reactor, is in fluid communication with the negative electrode of the electrochemical cell. The battery system also includes a gas store that includes a first compartment in fluid communication with the positive electrode and configured to store oxygen, a second compartment in fluid communication with the negative electrode and configured to store carbon dioxide and water, and a third compartment in fluid communication with the negative electrode or the reactor and configured to store methane. The gas store also includes a first barrier between the first compartment and the second compartment, and a second barrier between the second compartment and the third compartment. The gas store and the electrochemical cell are configured to form a closed system. In an embodiment, the closed system may have a constant volume. The second compartment may be in fluid communication with an outlet of the negative electrode, the third compartment may be in fluid communication with an inlet of the negative electrode. In an aspect, the first compartment may be in fluid communication with an inlet of the positive electrode.

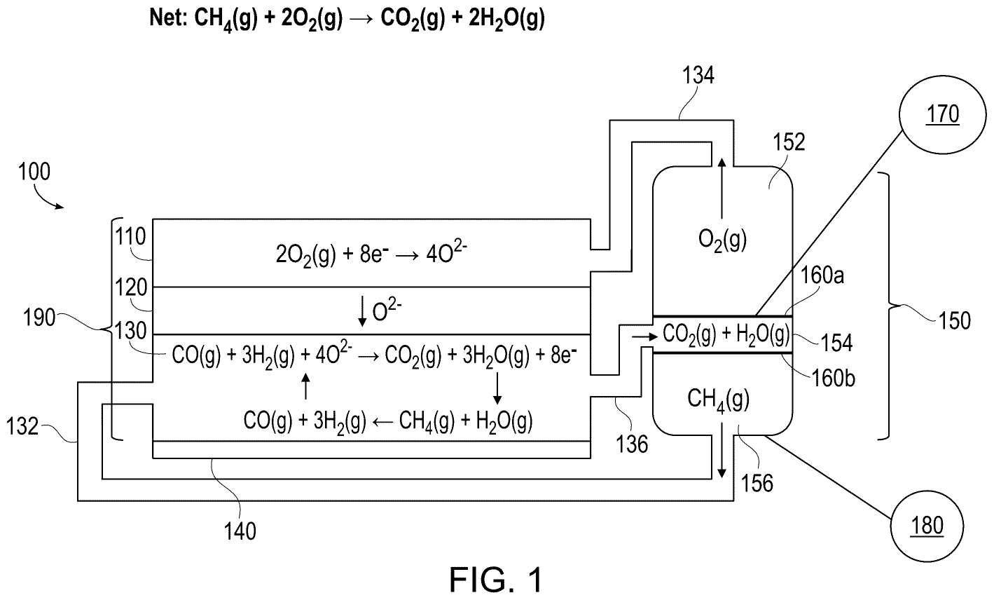

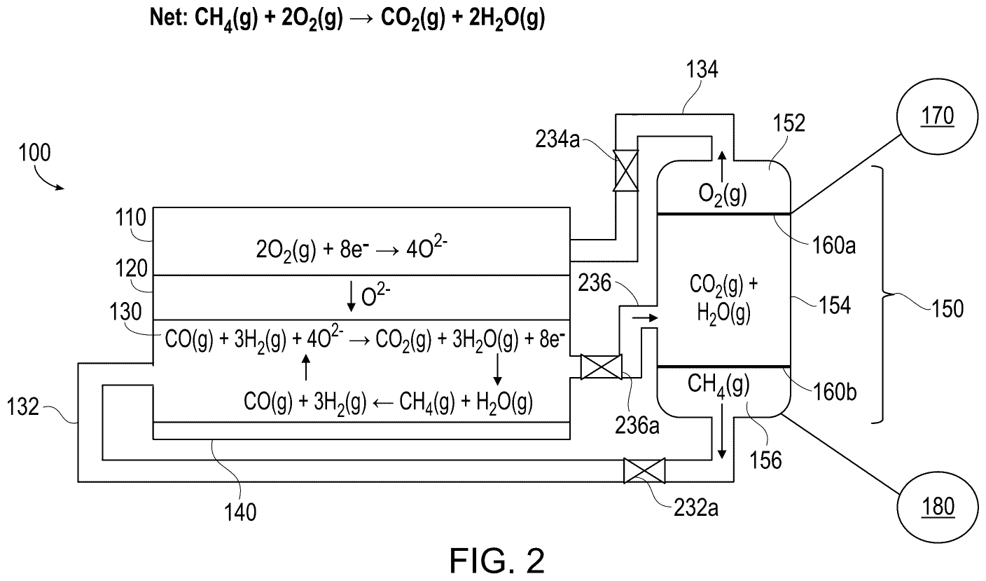

The methane-oxygen battery system may be configured with the storage arrangement shown in FIGS. 1 and 2, which are described in further detail below. During charge, electrical energy is stored by converting a stored gaseous reactant mixture comprising water vapor and carbon dioxide to stored gaseous products comprising oxygen and methane. The storage arrangement comprises three compartments to hold the stored gaseous reactant mixture and the two stored gaseous products. The three compartments are separated by at least two barriers, each of which is movable. The system may have a constant gas pressure of 0.1 to 10 megapascal (MPa), 0.2 to 8 MPa, or 0.4 to 4 MPa. Use of 3 MPa (30 bar) is mentioned. The hot zone, comprising the electrochemical cell, may be maintained at 550° C., while the remainder of the system may be maintained at about 250° C. to keep water in a vapor phase. Having the water in a vapor phase can be preferred to facilitate a passive flow methane-oxygen battery system using stored gaseous reactants and products.

On charge, H₂O and CO₂, which are the gaseous electrochemical reaction reactants, are electrolyzed at the negative electrode to yield H₂, CO, and oxygen ions (O₂⁻), the latter of which is transported across the electrolyte to the positive electrode to form O₂ gas. The gaseous electrochemical reaction products are therefore H₂, CO, and O₂. The H₂ and CO thermochemically react, for example, on a nickel-containing catalyst in the negative electrode compartment in the methane-oxygen battery system to form methane. In some embodiments, the methane formation reaction occurs directly on the negative electrode.

The combination of electrochemical and chemical reactions generates pressure and concentration differences in the gases and may provide an automatic gas flow between the gas store and the electrochemical cell during charge and discharge.

Turning now to FIGS. 1 and 2, a methane-oxygen battery system according to one or more embodiments is provided. The methane-oxygen battery system 100 includes an electrochemical cell 190 comprising a positive electrode 110, a negative electrode 130, and an electrolyte 120 that is between the positive electrode 110 and the negative electrode 130. The reactor 140 is in fluid communication with the negative electrode 130. For example, the reactor 140 may be disposed within a same compartment as the negative electrode 130, or may be physically separated and in fluid communication, but embodiments are not limited thereto.

The methane-oxygen battery system 100 may include a gas store 150. The gas store 150 includes a first compartment 152 that is in fluid communication with the positive electrode 110, and is configured to store oxygen. The first compartment 152 may be connected to the electrochemical cell 190 via conduit 134. The gas store 150 also includes a second compartment 154 that is in fluid communication with an outlet of the negative electrode 130, where the second compartment 154 is configured to store carbon dioxide and water. The second compartment 154 may be connected to the electrochemical cell 190 via conduit 136. The gas store 150 further includes a third compartment 156 that is in fluid communication with an inlet of the negative electrode 130, where the third compartment 156 is configured to store methane. The third compartment 156 may be connected to the electrochemical cell 190 via conduit 132. It should be noted that during charge, the second compartment 154 is in fluid communication with an inlet of the negative electrode 130 and configured to provide carbon dioxide and water, whereas the third compartment 156 is in fluid communication with an outlet of the negative electrode 130 and configured to store methane. As used herein, when the gas store 150 is referred to as being able to store a component, it means that the gas store 150 is configured to both receive the component for storage and configured to deliver the component from storage, during charge or discharge, respectively.

The first compartment is configured to provide oxygen to the positive electrode on discharge, and is configured to store oxygen on charge. The second compartment is configured to store carbon dioxide and water on discharge, and is configured to provide carbon dioxide and water on charge. The third compartment is configured to provide methane to the reactor on discharge, and is configured to store methane on charge.

The gas store 150 includes a first barrier 160a that is disposed between the first compartment 152 and the second compartment 154. The gas store also includes a second barrier 160b that is disposed between the second compartment 154 and the third compartment 156. FIGS. 1 and 2 depict the methane-oxygen battery system 100 in different states of charge. For example, in FIG. 1, the volume of oxygen in the first compartment 152 and the volume of methane in the third compartment 156 may be at a maximum. In FIG. 2, the same methane-oxygen battery system 100 from FIG. 1 is shown when the battery system in a discharged state, where it can be seen that the volume of oxygen in the first compartment 152 and the volume of methane in the third compartment 156 are at a minimum. Similarly, in FIG. 1, the volume of the second compartment 154 is at a minimum when the methane-oxygen battery system 100 is in a charged state, whereas in FIG. 2, the volume of the second compartment 154 is at a maximum when the methane-oxygen battery system 100 is in a charged state.

The gas store 150 may further include a fuel gauge 170 that is configured to determine a state of charge based on a position of at least one of the first barrier 160a or the second barrier 160b. In an aspect, the methane-oxygen battery system 100 may comprise the fuel gauge 170 configured to determine a state of charge based on a position of the first barrier 160a and a fuel gauge 175 configured to determine a state of charge based on a position of the second barrier 160b. In FIG. 1, the methane-oxygen battery system 100 is in a charged state, and the volume of oxygen in the first compartment 152 and the volume of methane in the third compartment 156 can be at a maximum, where the position of the first barrier 160a and/or the position of the second barrier 160b may be used to determine the state of charge. In FIG. 2, the methane-oxygen battery system 100 from FIG. 1 is shown when the battery system is in a discharged state, where it can be seen that the volume of oxygen in the first compartment 152 and the volume of methane in the third compartment 156 are at a minimum, where the position of the first barrier 160a and/or the position of the second barrier 160b may be used to determine the state of charge. Similarly, in FIG. 1, the volume of the second compartment 154 is at a minimum when the methane-oxygen battery system 100 is in a charged state, where the position of the first barrier 160a and/or the position of the second barrier 160b may be used to determine the state of charge. In FIG. 2, the volume of the second compartment 154 is at a maximum when the methane-oxygen battery system 100 is in a discharged state, where the position of the first barrier 160a and/or the position of the second barrier 160b may be used to determine the state of charge.

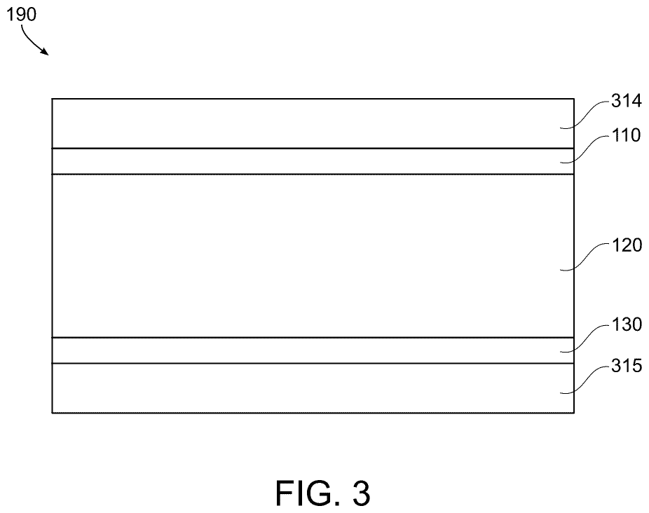

As shown in FIG. 3, in some embodiments, the electrochemical cell 190 may further include a positive interconnect 314 in contact with the positive electrode 110 and a negative interconnect 315 in contact with the negative electrode 130. The positive interconnect 314 and the negative interconnect 315 may be used to connect the positive electrodes and negative electrodes, respectively, between multiple electrochemical cells. In some embodiments, the interconnects (314, 315) may be current collectors for the respective electrodes. In some embodiments, the reactor 140 may be disposed in an interconnect 315.

In an aspect, the methane-oxygen battery system 100 may comprise a fuel gauge 180 configured to determine a state of charge based on a mass of a gas in the gas store, wherein the mass of gas in the gas store comprises a mass of oxygen in the first compartment, a mass of carbon dioxide and water in the second compartment, a mass of methane in the third compartment, or a combination thereof. The fuel gauge 180 may comprise a mass sensor of a scale or a load cell configured to measure the mass of the gas in the gas store.

The methane-oxygen battery system 100 may comprise a plurality of fuel gauges. The plurality of fuel gauges may comprise a fuel gauge configured to determine a state of charge based on a mass of the gas in the gas store, a fuel gauge configured to determine a state of charge based on a position of the first barrier, a fuel gauge configured to determine a state of charge based on a position of the second barrier, or a combination thereof. In an aspect, the methane-oxygen battery system 100 may comprise a first fuel gauge configured to determine a state of charge based on a position of at least one of the first barrier or the second barrier, and a second fuel gauge configured to determine a state of charge based on a mass of a gas in the gas store, wherein the mass of the gas in the gas store comprises a mass of the oxygen in the first compartment, a mass of the carbon dioxide and water in the second compartment, a mass of the methane in the third compartment, or a combination thereof. In another aspect, the methane-oxygen battery system 100 may comprise a first fuel gauge configured to determine a state of charge based on a position of the first barrier, and a second fuel gauge configured to determine a state of charge based on a mass of the gas in the gas store, wherein the mass of the gas in the gas store comprises a mass of the oxygen in the first compartment, a mass of the carbon dioxide and water in the second compartment, a mass of the methane in the third compartment, or a combination thereof, and a third fuel gauge configured to determine a state of charge based on a position of the second barrier. During charge, as oxygen is produced at the positive electrode 110, the resulting pressure increase causes the first barrier 160a and the second barrier 160b to move to balance the pressure. The stoichiometry of methane:water:carbon dioxide is 1:3:1, that is one molecule of methane is produced in the negative electrode 130 chamber from three molecules of H₂O and one molecule of CO₂, resulting in a pressure decrease that causes the first barrier 160a and the second barrier 160b to move in a same direction. In another embodiment, the system further includes one or more valve(s) (232a, 234a, 236a) that are disposed in any of the conduits 132, 134, and/or 136. The flow direction can be selected and switched by use of a valve, such as an electronically controlled valve. In an aspect, the valve is selected to allow either one-way flow in a first direction, or to allow one-way flow in the opposite, i.e., second, direction. In an aspect, the valves may be one-way valves or check valves, where when changing between charge and discharge, the valves may be switched to select the gas pathways that contain check valves corresponding to the desired flow directions, which ensure the gases flow one-way in the desired directions. The valves (232a, 234a, 236a) can also be configured to determine an amount of the methane, the carbon dioxide/water mixture, or the oxygen on the basis of the metered amount of the gas passing through the valve(s) to determine a state of charge of the system.

During charge, the volume increases in the first compartment 152 that stores O₂ and the third compartment 156 that stores the mixture comprising methane, whereas the volume decreases in the second compartment 154 that stores the mixture comprising H₂O and CO₂. Storage with a single pressure vessel is therefore possible, and a constant pressure and total volume may be maintained during charge and discharge.

In some embodiments, the methane-oxygen battery system 100 may further include a fuel gauge 180 for sensing the mass of the gas in the gas store 150. For example, the mass of the gas in the gas store 150 may vary based on the relative amounts of oxygen, carbon dioxide, water, and methane, which may be used to determine the amount of fuel during charging and discharging.

In some embodiments, the reactor 140 may be a steam reforming reactor configured to convert methane and water to carbon monoxide and hydrogen, and to convert carbon monoxide and hydrogen to carbon dioxide and water. For example, the reactor 140 may be configured to convert methane and water to carbon monoxide and hydrogen on discharge; and configured to convert carbon monoxide and hydrogen to methane and water on charge.

The gas store 150 and the electrochemical cell form a closed system with a constant volume. In some embodiments, the methane-oxygen battery system 100 may be configured to generate an automatic gas flow between the electrochemical cell and the gas store 150.

In some embodiments, the (i) the oxygen; (ii) the carbon dioxide and the water; and (iii) the methane are configured to be pressure balanced in the gas store. In an aspect, the (i) the oxygen; (ii) the carbon dioxide and the water; and (iii) the methane are configured to have the same pressure in the gas store.

In some embodiments, the first compartment and the second compartment are configured to be pressure balanced, and the second compartment and the third compartment are configured to be pressure balanced. In an aspect, the first compartment, the second compartment, and the third compartment are configured to have the same pressure.

In some embodiments, the first and the second barrier may each independently be a movable barrier. For example, the first barrier and the second barrier may each independently be a movable piston, movable partition, a flexible diaphragm, an elastic diaphragm, an inflatable bladder, or a combination thereof.

In some embodiments, the electrochemical cell is configured to operate passively, preferably without a pump, a compressor, a blower, or a condenser.

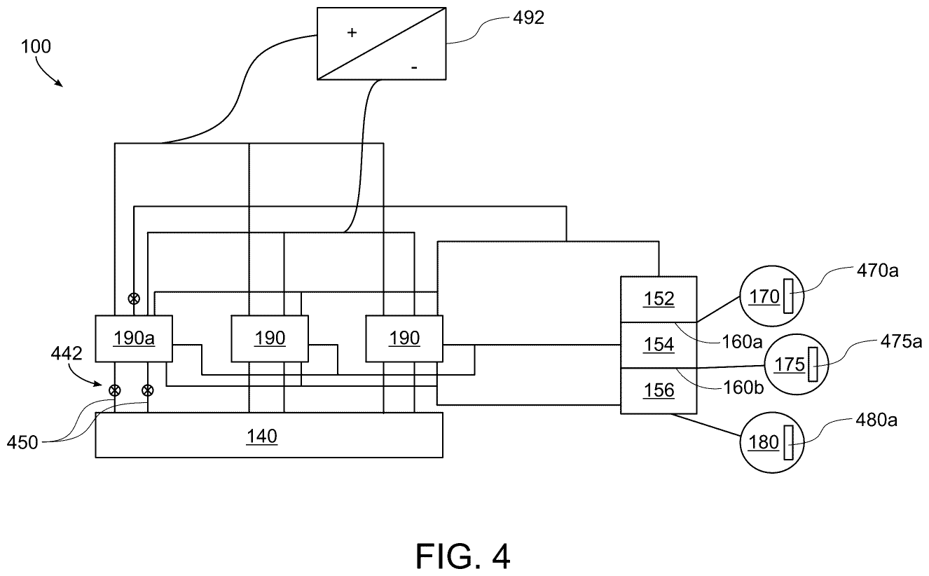

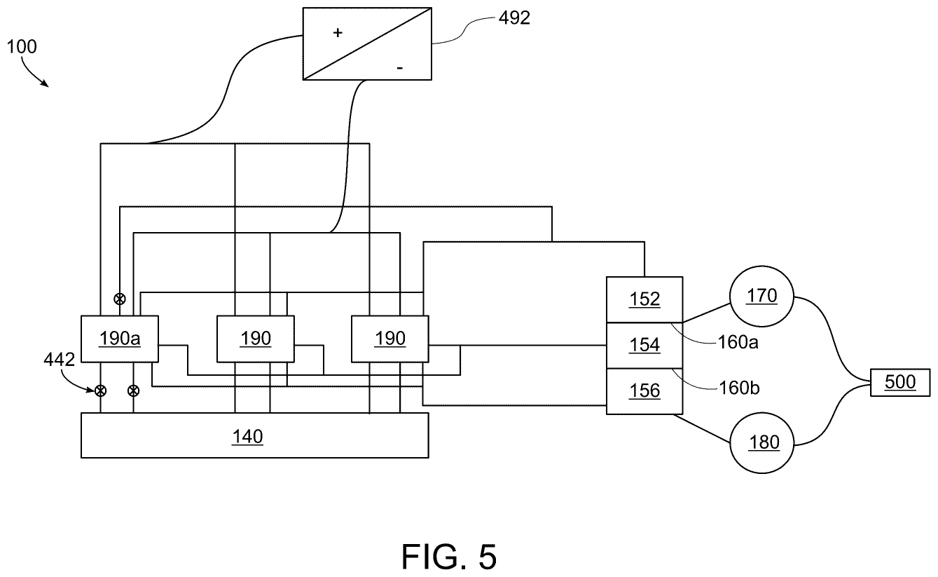

The interconnects (314, 315) may be connected to an external circuit 492 as shown in FIGS. 4 and 5 for charging or discharging of the methane-oxygen battery system 100. The interconnects (314, 315) may be connected to other electrical features by welding or soldering connections. In some embodiments, the interconnects (314, 315) may be connected to other electrical features by mechanical pressure fittings, which include bolted, spring loaded, or other suitable mechanical contacting terminals.

In some embodiments, the interconnects (314, 315) may have surfaces that are coated with an oxidation resistant coating. The oxidation resistant coating can include nickel (Ni), nickel-alloys, chrome (Cr), chrome-alloys, gold (Au), and/or other oxidation resistant, conductive materials. The electrical interfaces can be coated with a joint compound. The joint compounds can be a liquid or gel component that covers the exposed metallic surface to prevent corrosion and/or passivation.

The positive electrode 110 of the electrochemical cell 190 may be any suitable oxygen electrode. Exemplary positive electrode materials include lanthanum strontium cobalt ferrite (LSCF), strontium-doped lanthanum manganate, strontium oxide and bismuth oxide doped with lanthanum manganate, lanthanum strontium cobaltite (LSC), barium strontium iron cobaltite (BSCF), strontium doped hafnium oxide, europium cobaltite (SSC), or the like, or a combination thereof. In some embodiments, the positive electrode 110 may include lanthanum strontium cobalt ferrite (LSCF). In other embodiments, the positive electrode may include Bi₂O₃—MO (wherein M is one or more of Ca, Sr, Ba, or Cu), Bi₂O₃—MO₂ (wherein M is one or more of Ti, Zr, or Te), Bi₂O₃—MO₃ (wherein M is one or more of W or Mo), Bi₂O₃—M₂O₅ (wherein M is one or more of V, Nb, or Ta), Bi₂O₃—M₂O₃ (wherein M is one or more of La, Sm, Y, Gd, or Er), nickel, a lithiated nickel oxide, or a combination thereof. Preferably, the positive electrode is porous such that it is permeable for diffusing gaseous electrochemical reactants (e.g., oxygen).

The negative electrode 110 of the electrochemical cell 190 may be any suitable anode material. The negative electrode 110 may include an electron-conducting material and ceria doped with one or more rare earth elements such as Gd, Sm, Pr, La, Y, or Yb, and/or one or more other elements such as Mn or Fe. The electron-conducting material may include ceramic oxides such as Sr-doped lanthanum chromite, Nb-, La-, or Y-doped strontium titanate, strontium iron molybdate, or the like, or a combination thereof, and/or metals such as copper, silver, or the like, or a combination thereof. Exemplary negative electrode materials include nickel oxide (NiO), cerium oxide (CeO₂), copper oxide (CuO), strontium titanate (SrTiO₃), yttrium oxide doped strontium titanate (YST), thorium oxide doped strontium titanate (SST), or the like, or a combination thereof. Other exemplary negative electrode materials may include ceramic oxides such as lanthanum strontium chromite, strontium iron molybdate, copper, silver, or the like, or a combination thereof. Preferably, the negative electrode is porous such that it is permeable for diffusing gaseous electrochemical reaction reactants (e.g., CH₄, CO₂, and H₂O).

The electrolyte 120 is disposed between the positive electrode 110 and the negative electrode 130. Any suitable electrolyte material, or combination of materials, may be used, preferably an oxide ion conducting electrolyte having an oxygen ion conductivity of 0.1 to 100 siemens per meter (S/m) at 700° C. In some embodiments, the electrolyte may include a solid oxide electrolyte.

Examples of the solid oxide electrolytes include yttrium oxide stabilized zirconia (YSZ), hafnium oxide stabilized zirconia (HSZ), gadolinium oxide doped cerium oxide (GDC), strontium oxide doped cerium oxide (SDC), hafnium oxide dope cerium oxide, strontium and magnesium doped lanthanum gallate (LSGM), yttrium oxide doped cerium oxide (YDC), strontium oxide, magnesium oxide, Li₂₊₂ₓZn₁₋ₓGeO₄, Li-β-alumina, lithium phosphorus oxynitride (LiPON), Li_{1.3}Al_{0.3}Ti_{1.7}(PO₄)₃, LaGaO₃-containings oxides, Sr(Ce, Yb) O₃-containing oxides, BaCeO₃-containing oxides, perovskite oxides, (Ba,La,Sr)₂In₂O₅-containing oxides, LaCeMgO₃-containing oxides, or the like, or a combination thereof.

In an aspect, the electrochemical cell may include a multilayered electrolyte including a first layer and a second layer, wherein the first layer and the second layer are different from each other. For example, the first layer may include a first electrolyte including a first solid oxygen ion conductor, and the second layer may include a second electrolyte including a second solid oxygen ion conductor electrolyte different from the first solid oxygen ion conductor in composition, form, or both.

Additional details of the electrochemical cell can be determined by one of skill in the art without undue experimentation, and are also available in The Handbook of Fuel Cells-Fundamentals, Technology, and Applications, W. Vielstich, H. A. Gasteiger, and A. Lamm, Eds., 2010, the content of which is incorporated herein by reference in its entirety, for example.

In some embodiments, the methane-oxygen battery system 100 further includes a heat exchanger (not shown) configured to exchange heat between the reactor 140 and the electrochemical cell. In some embodiments, at least one of the reactor and the electrochemical cell are disposed in a thermal chamber. Any suitable thermal chamber may be used. The thermal chamber may be configured to provide a desired operating temperature for the removable electrochemical cell, the reactor, or both. By using separate thermal chambers for the electrochemical cell (or stack of cells) and the reactor, to the system may be configured to provide for deactivation of the heating function to selective parts of the methane-oxygen battery system when replacing a removable electrochemical cell (or stack of cells), without disturbing the heating function in the other removable electrochemical cells.

The thermal chamber may be configured to provide and maintain any desirable temperature. In an aspect, the thermal chamber may be configured to provide an operating temperature that is greater than 200° C., greater than 300° C., greater than 500° C., or greater than 1000° C. For example, the thermal chamber may maintain a temperature of 400° C. to 1,500° C., or 500° C. to 1,000° C.

In an aspect, the methane-oxygen battery system can further comprise a heat exchanger. Without wishing to be bound by theory, it is believed that the presence of the heat exchanger can increase the efficiency of the methane-oxygen battery system by exchanging heat between the reactor and the electrochemical cell. Thus, when present, the heat exchanger can be configured to exchange heat between the reactor and the electrochemical cell.

The methane-oxygen battery system may include at least one removable electrochemical cell 190a, for example as shown in FIG. 4 and FIG. 5, and may include multiple removable electrochemical cells. A plurality of electrochemical cells may be used in the form of an electrochemical cell stack, e.g., to provide a selected voltage, in which the electrochemical cells are interconnected to form a “stack.” The entire stack may be removable from the methane-oxygen battery system. Also mentioned is a configuration in which the individual electrochemical cells of a stack are removable from the methane-oxygen battery system. In some embodiments, the electrochemical cell may include a plurality of electrochemical cells, wherein at least one electrochemical cell of the plurality of electrochemical cells is in electrical contact with an external circuit 492 (as shown in FIG. 4). In some embodiments, at least one electrochemical cell of the plurality of electrochemical cells is a removable electrochemical cell. For example, as shown in FIG. 4, a disconnect 442 can be provided to facilitate isolating and removing a stack. For example, at least one removable electrochemical cell is configured to be selectively isolated from the methane-oxygen battery system and/or to be selectively isolated from the gas store. In some embodiments, the methane-oxygen battery system is configured to operate when at least one removable electrochemical cell is isolated from the system and at least one electrochemical cell is not isolated from the system. Preferably, the removable electrochemical cell can be configured to be selectively isolated from the methane-oxygen battery system. In various aspects, it is possible to isolate the cell electrically, fluidically, mechanically, or thermally, and/or combinations and permutations thereof. In an aspect, each removable electrochemical cell can be configured to be independently isolated from the system. In another aspect, a grouping comprising a plurality of electrochemical cells can be isolated from the system; such a grouping can be advantageous because it reduces the cost of components and materials required to isolate electrochemical cells from the overall system. In certain aspects, the methane-oxygen battery system can be configured to operate when one or more of the removable electrochemical cells is isolated from the system and at least one electrochemical cell is not isolated from the system. In certain aspects, the methane-oxygen battery system may not be operable when removable electrochemical cells are isolated from the system.

The positive electrode and the negative electrode of the electrochemical cell or stack of electrochemical cells are connected to an external circuit. The electrochemical cell can be configured to be selectively isolated from the external circuit. When a plurality of electrochemical cells is present, they may be connected in any suitable combination of series and/or in parallel connections to form an assembly of cells (i.e., a “stack”). In an aspect, each electrochemical cell of the plurality of electrochemical cells can be electrically connected to an external circuit in parallel. Electrical switches may be used to selectively isolate the electrochemical cell from the external circuit. The methane-oxygen battery system may be further connected to a power management controller in electrical communication with the electrochemical cells and configured to control a charge or a discharge of each electrochemical cell.

In some embodiments, the methane-oxygen battery system may further include a processor (470a, 475a, 480a, as shown in FIG. 4) configured to receive information relating to the position of the first barrier and/or the second barrier, a mass of the gas in the gas store, wherein the mass of the gas in the gas store comprises a mass of the oxygen in the first compartment, a mass of the carbon dioxide and the water in the second compartment, a mass of the methane in the third compartment, or a combination thereof, and to determine the state of charge based on the position of the first barrier and/or the position of the second barrier, the mass of the gas in the gas store, or a combination thereof.

In an embodiment, one or more of the processors (470a, 475a, 480a) may be disposed outside of a fuel gauge. In an aspect, a central processor 500 may be disposed outside of the fuel gauge or fuel gauges and may serve as a processing unit for two or more fuel gauges. For example, the central processor 500 may serve as the processing unit for fuel gauge 170 and fuel gauge 180 as shown in FIG. 5.

Any suitable reactor may be used, such as a catalytic reactor. In some embodiments, the reactor may be disposed within a negative electrode compartment also comprising the negative electrode of the electrochemical cell. For example, the reactor may be disposed in an interconnect 315 of an electrochemical cell or a plurality of reactors may be each individually disposed in a plurality of interconnects 315 of a plurality of electrochemical cells. In some embodiments, the reactor may be disposed in a separate compartment in fluid communication with the negative electrode and separated from the electrochemical cell via an interconnect 450 (e.g., as shown in FIG. 4). Another aspect provides a battery fuel gauge configured to determine a state of charge of a methane-oxygen battery. The battery fuel gauge comprises a processor configured to receive information relating to a position of a first barrier and/or a position of a second barrier of a gas store and to determine the state of charge based on the position of the first barrier and/or the position of the second barrier. The electrochemical cell is as described herein. The gas store includes a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, a first barrier between the first compartment and the second compartment, and a second barrier between the second compartment and the third compartment. The gas store and the electrochemical cell form a system with a constant volume.

Still another aspect provides a battery fuel gauge configured to determine a state of charge of a methane-oxygen battery. The battery fuel gauge comprises a processor configured to receive information relating to a mass of a gas in a gas store and to determine the state of charge based on the mass of gas in the gas store. The electrochemical cell is as described herein. The gas store includes a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, a first barrier between the first compartment and the second compartment, and a second barrier between the second compartment and the third compartment. The gas store and the electrochemical cell form a system with a constant volume. The mass of the gas in the gas store comprises a mass of the oxygen in the first compartment, a mass of the carbon dioxide and the water in the second compartment, a mass of the methane in the third compartment, or a combination thereof. In an aspect, the fuel gauge is configured to determine the mass of the oxygen in the first compartment, the mass of the carbon dioxide and the water in the second compartment, the mass of the methane in the third compartment, or a combination thereof. For example, the fuel gauge may be configured to determine the mass of the gas in one compartment, two compartments, or three compartments. In an aspect, the fuel gauge may be configured to determine the mass of the oxygen in the first compartment, the mass of the carbon dioxide and the water in the second compartment, and the mass of the methane in the third compartment.

In an aspect, a methane-oxygen battery system may be an active system. In an aspect, the methane-oxygen battery system may comprise an electrochemical cell including a positive electrode, a negative electrode, and an electrolyte between the positive electrode and the negative electrode; a reactor in fluid communication with the negative electrode; a fuel gauge configured to determine a state of charge; a gas inlet in fluid communication with the positive electrode and configured to provide oxygen on discharge of the system, a fuel inlet in fluid communication with the negative electrode or the reactor and configured to provide methane on discharge of the system, and an exhaust gas outlet in fluid communication with the negative electrode and configured to exhaust carbon dioxide and water on discharge of the system.

In an aspect, the methane-oxygen battery may be configured to actively generate a gas flow to the electrochemical cell. The electrochemical cell may be configured to operate actively with a pump, a compressor, a blower, a condenser, or a combination thereof. On charge of the system the gas inlet may be configured to exhaust oxygen, the fuel inlet is configured to exhaust methane, and the exhaust gas outlet is configured to provide carbon dioxide and water. The fuel gauge may be configured to determine the state of charge based on an amount of the oxygen, the methane, the carbon dioxide, the water, or a combination thereof passing through the system. At least one of the gas inlet, the fuel inlet, or the exhaust gas outlet may comprise a valve configured to control a flow of the oxygen, a flow of the carbon dioxide and water, or a flow of the methane, respectively. The valve(s) may be configured to maintain, monitor, and adjust the flow of the oxygen, carbon dioxide and water, the methane, or a combination thereof to and from the electrochemical cell and reactor. The valves may be configured to determine an amount of the oxygen, an amount of the carbon dioxide and the water, an amount of the methane, or a combination thereof on the basis of a metered amount of the oxygen, the carbon dioxide and the water, the methane, or a combination thereof of passing through the valve(s) to determine the state of charge of the system.

Also provided is a method of operating a methane-oxygen battery system. The method includes providing the methane-oxygen battery system as provided herein, supplying electricity, carbon dioxide, and water to the electrochemical cell to charge the battery system; and discharging the methane-oxygen battery system to convert carbon monoxide, hydrogen, and oxygen to carbon dioxide and water, and produce electricity. During charge, hydrogen and carbon monoxide are converted in the reactor to methane and water, carbon dioxide and water are converted to carbon monoxide, hydrogen, and oxygen by the electrochemical cell, the carbon dioxide and a portion of the water are provided by the gas store, and oxygen and methane are stored in the gas store. During discharge, methane and water are converted in the reactor to hydrogen and carbon monoxide, carbon monoxide, hydrogen, and oxygen are converted to carbon dioxide and water by the electrochemical cell, the carbon dioxide and a portion of the water produced by the electrochemical reactor are stored in the gas store, and the methane is provided by the gas store.

In an aspect, a method of operating a methane-oxygen battery system may comprise providing a methane-oxygen battery system; supplying electricity, carbon dioxide, and water to the electrochemical cell to charge the battery system, wherein the carbon dioxide and a portion of the water are provided by the exhaust gas outlet, the carbon dioxide and the water are converted to carbon monoxide, hydrogen, and oxygen by the electrochemical cell, and the hydrogen and the carbon monoxide are converted to methane and water by the reactor; and discharging the methane-oxygen battery system to convert carbon monoxide, hydrogen, and oxygen to carbon dioxide and water, and produce electricity, wherein the methane is provided by the fuel inlet, the oxygen is provided by the gas inlet, the methane and the water are converted to hydrogen and carbon monoxide by the reactor, the carbon monoxide, the hydrogen, and the oxygen are converted to carbon dioxide and water by the electrochemical cell, and the carbon dioxide and a portion of the water produced by the electrochemical reactor are exhausted by the exhaust gas outlet.

In some embodiments, provided is a methane-oxygen battery system, comprising: an electrochemical cell comprising a positive electrode, a negative electrode, and an electrolyte between the positive electrode and the negative electrode; and a reactor in fluid communication with the negative electrode; a gas store comprising a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, a first barrier between the first compartment and the second compartment, a second barrier between the second compartment and the third compartment, wherein the gas store and the electrochemical cell form a closed system with a constant volume; and a fuel gauge configured to determine a state of charge based on a position of at least one of the first barrier or the second barrier, wherein the reactor is a steam reforming reactor that is configured to convert methane and water to carbon monoxide and hydrogen on discharge; and configured to convert carbon monoxide and hydrogen to methane and water on charge.

In some embodiments, provided is a methane-oxygen battery system, comprising: an electrochemical cell comprising a positive electrode, a negative electrode, and an electrolyte between the positive electrode and the negative electrode; and a reactor in fluid communication with the negative electrode; a gas store comprising a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, a first barrier between the first compartment and the second compartment, a second barrier between the second compartment and the third compartment, wherein the gas store and the electrochemical cell form a closed system with a constant volume; and a fuel gauge configured to determine a state of charge based on a position of at least one of the first barrier or the second barrier, wherein the methane-oxygen battery system is configured to generate an automatic gas flow between the electrochemical cell and the gas store.

In some embodiments, provided is a methane-oxygen battery system, comprising: an electrochemical cell comprising a positive electrode, a negative electrode, and an electrolyte between the positive electrode and the negative electrode; and a reactor in fluid communication with the negative electrode; a gas store comprising a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, a first barrier between the first compartment and the second compartment, a second barrier between the second compartment and the third compartment, wherein the gas store and the electrochemical cell form a closed system with a constant volume; and a fuel gauge configured to determine a state of charge based on a position of at least one of the first barrier or the second barrier, wherein the first compartment and the second compartment are configured to be pressure balanced, and the second compartment and the third compartment are configured to be pressure balanced.

In some embodiments, provided is a methane-oxygen battery system, comprising: an electrochemical cell comprising a positive electrode, a negative electrode, and an electrolyte between the positive electrode and the negative electrode; and a reactor in fluid communication with the negative electrode; a gas store comprising a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, a first barrier between the first compartment and the second compartment, a second barrier between the second compartment and the third compartment, wherein the gas store and the electrochemical cell form a closed system with a constant volume; and a fuel gauge configured to determine a state of charge based on a position of at least one of the first barrier or the second barrier, wherein the methane-oxygen battery system is configured to generate an automatic gas flow between the electrochemical cell and the gas store, and wherein the electrochemical cell is configured to operate without a pump, a compressor, a blower, a condenser, or a combination thereof.

In some embodiments, provided is a methane-oxygen battery system, comprising: an electrochemical cell comprising a positive electrode, a negative electrode, and an electrolyte between the positive electrode and the negative electrode; and a reactor in fluid communication with the negative electrode; a gas store comprising a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, a first barrier between the first compartment and the second compartment, a second barrier between the second compartment and the third compartment, wherein the gas store and the electrochemical cell form a closed system with a constant volume; and a fuel gauge configured to determine a state of charge based on a position of at least one of the first barrier or the second barrier, wherein the first barrier and the second barrier are each independently a movable piston, moveable partition, a flexible diaphragm, an elastic diaphragm, an inflatable bladder, or a combination thereof, and wherein the first compartment and the second compartment are configured to be pressure balanced, and the second compartment and the third compartment are configured to be pressure balanced.

In some embodiments, provided is a methane-oxygen battery system, comprising: an electrochemical cell comprising a positive electrode, a negative electrode, and an electrolyte between the positive electrode and the negative electrode; and a reactor in fluid communication with the negative electrode; a gas store comprising a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, a first barrier between the first compartment and the second compartment, a second barrier between the second compartment and the third compartment, wherein the gas store and the electrochemical cell form a closed system with a constant volume; and a fuel gauge configured to determine a state of charge based on a position of at least one of the first barrier or the second barrier, and further comprising a processor configured to receive information relating to the position of the first barrier and/or the second barrier, and to determine the state of charge based on the position of the first barrier and/or the second barrier.

In some embodiments, provided is a methane-oxygen battery system, comprising: an electrochemical cell comprising a positive electrode, a negative electrode, and an electrolyte between the positive electrode and the negative electrode; and a reactor in fluid communication with the negative electrode; a gas store comprising a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, a first barrier between the first compartment and the second compartment, a second barrier between the second compartment and the third compartment, wherein the gas store and the electrochemical cell form a closed system with a constant volume; and a fuel gauge configured to determine a state of charge based on a position of at least one of the first barrier or the second barrier, wherein the reactor is disposed within a compartment of a negative electrode of the electrochemical cell; disposed in a separate compartment from the electrochemical cell; or disposed in an interconnect, wherein the electrochemical cell comprises a plurality of electrochemical cells that are connected via the interconnect.

In some embodiments, the method of operating a methane-oxygen battery system further includes determining the state of charge of the methane-oxygen battery system using the fuel gauge or the plurality of fuel gauges, as provided herein.

This disclosure further encompasses the following aspects.

Aspect 1. A methane-oxygen battery system, comprising: an electrochemical cell comprising a positive electrode, a negative electrode, and an electrolyte between the positive electrode and the negative electrode; a reactor in fluid communication with the negative electrode; a fuel gauge; and a gas store comprising a first compartment in fluid communication with the positive electrode and configured to store oxygen, a second compartment in fluid communication with the negative electrode and configured to store carbon dioxide and water, a third compartment in fluid communication with the negative electrode or the reactor and configured to store methane, a first barrier between the first compartment and the second compartment, and a second barrier between the second compartment and the third compartment, wherein the gas store and the electrochemical cell form a closed system; wherein the fuel gauge is configured to determine a state of charge based on a position of at least one of the first barrier or the second barrier.

Aspect 2. The methane-oxygen battery system of aspect 1, wherein the closed system has a constant volume.

Aspect 3. The methane-oxygen battery system of aspects 1 or 2, wherein the reactor is a steam reforming reactor configured to convert methane and water to carbon monoxide and hydrogen, and to convert carbon monoxide and hydrogen to carbon dioxide and water.

Aspect 4. The methane-oxygen battery system of any of aspects 1 to 3, wherein the reactor is configured to convert methane and water to carbon monoxide and hydrogen on discharge; and configured to convert carbon monoxide and hydrogen to methane and water on charge.

Aspect 5. The methane-oxygen battery system of any of aspects 1 to 4, wherein the methane-oxygen battery system is configured to passively generate a gas flow between the electrochemical cell and the gas store.

Aspect 6. The methane-oxygen battery system of any of aspects 1 to 5, wherein the (i) the oxygen; (ii) the carbon dioxide and the water; and (iii) the methane are configured to be pressure balanced in the gas store.

Aspect 7. The methane-oxygen battery system of any of aspects 1 to 6, wherein the (i) the oxygen; (ii) the carbon dioxide and the water; and (iii) the methane are configured to have a same pressure in the gas store.

Aspect 8. The methane-oxygen battery system of any of aspects 1 to 6, wherein the first compartment and the second compartment are configured to be pressure balanced, and the second compartment and the third compartment are configured to be pressure balanced.

Aspect 9. The methane-oxygen battery system of any of aspects 1 to 8, wherein the first compartment, the second compartment, the third compartment are configured to have the same pressure.

Aspect 10. The methane-oxygen battery system of any of aspects 1 to 9, wherein the second compartment is in fluid communication with an outlet of the negative electrode of the electrochemical cell, and the third compartment is in fluid communication with an inlet of the negative electrode.

Aspect 11. The methane-oxygen battery system of any of aspects 1 to 10, wherein the first compartment is configured to provide oxygen to the positive electrode on discharge, and is configured to store oxygen on charge, the second compartment is configured to store carbon dioxide and water on discharge, and is configured to provide carbon dioxide and water on charge, and the third compartment is configured to provide methane to the reactor on discharge and is configured to store methane on charge.

Aspect 12. The methane-oxygen battery system of any of aspects 1 to 11, wherein the first barrier and the second barrier are each independently a movable piston, moveable partition, a flexible diaphragm, an elastic diaphragm, an inflatable bladder, or a combination thereof.

Aspect 13. The methane-oxygen battery system of any of aspects 1 to 12, wherein the electrochemical cell is configured to operate passively, preferably without a pump, a compressor, a blower, or a condenser.

Aspect 14. The methane-oxygen battery system of any of aspects 1 to 13, wherein the electrolyte comprises a solid oxide electrolyte.

Aspect 15. The methane-oxygen battery system of any of aspects 1 to 14, wherein the electrolyte has an oxygen ion conductivity of 0.1 to 100 siemens per meter at 700° C.

Aspect 16. The methane-oxygen battery system of any of aspects 1 to 15, further comprising a heat exchanger configured to exchange heat between the reactor and the electrochemical cell.

Aspect 17. The methane-oxygen battery system of any of aspects 1 to 16, wherein at least one of the reactor and the electrochemical cell are disposed in a thermal chamber.

Aspect 18. The methane-oxygen battery system of any of aspects 1 to 17, wherein the electrochemical cell comprises a plurality of electrochemical cells, wherein at least one electrochemical cell of the plurality of electrochemical cells is in electrical contact with an external circuit.

Aspect 19. The methane-oxygen battery system of aspect 18, wherein at least one electrochemical cell of the plurality of electrochemical cells is a removable electrochemical cell.

Aspect 20. The methane-oxygen battery system of aspect 19, wherein the at least one removable electrochemical cell is configured to be selectively isolated from the methane-oxygen battery system.

Aspect 21. The methane-oxygen battery system of aspect 19 or 20, wherein the at least one removable electrochemical cell is configured to be selectively isolated from the gas store.

Aspect 22. The methane-oxygen battery system of any of aspects 19 to 21, wherein the methane-oxygen battery system is configured to operate when the at least one removable electrochemical cell is isolated from the system and at least one electrochemical cell is not isolated from the system.

Aspect 23. The methane-oxygen battery system of any of aspects 1 to 22, further comprising a processor configured to receive information relating to the position of the first barrier and/or the second barrier, and to determine the state of charge based on the position of the first barrier and/or the second barrier.

Aspect 24. The methane-oxygen battery system of any of aspects 1 to 23, wherein the reactor is: disposed within a negative electrode compartment also comprising the negative electrode of the electrochemical cell; disposed in a separate compartment which is in fluid communication with the negative electrode and separated from the electrochemical cell; or disposed in an interconnect, wherein the electrochemical cell comprises a plurality of electrochemical cells that are connected via the interconnect.

Aspect 25. The methane-oxygen battery system of any of aspects 1 to 24, further comprising a second fuel gauge configured to determine a state of charge based on a mass of the gas in the gas store, wherein the mass of the gas in the gas store comprises a mass of oxygen in the first compartment, a mass of carbon dioxide and water in the second compartment, a mass of methane in the third compartment, or a combination thereof.

Aspect 26. A methane-oxygen battery system, comprising: an electrochemical cell comprising a positive electrode, a negative electrode, and an electrolyte between the positive electrode and the negative electrode; a reactor in fluid communication with the negative electrode; a fuel gauge; and a gas store comprising a first compartment in fluid communication with the positive electrode and configured to store oxygen, a second compartment in fluid communication with the negative electrode and configured to store carbon dioxide and water, a third compartment in fluid communication with the negative electrode and configured to store methane, a first barrier between the first compartment and the second compartment, and a second barrier between the second compartment and the third compartment, wherein the gas store and the electrochemical cell form a closed system; and the fuel gauge is configured to determine a state of charge based on a mass of a gas in the gas store, wherein the mass of gas in the gas store comprises a mass of oxygen in the first compartment, a mass of carbon dioxide and water in the second compartment, a mass of methane in the third compartment, or a combination thereof.

Aspect 27. The methane-oxygen battery system of aspect 26, wherein the fuel gauge comprises a plurality of fuel gauges, wherein the plurality of fuel gauges comprises a combination of two or more of (i) a first fuel gauge configured to determine a state of charge based on a mass of oxygen in the first compartment, (ii) a second fuel gauge configured to determine a state of charged based on a mass of carbon dioxide and water in the second compartment, and (iii) a third fuel gauge configured to determine a state of charge based on a mass of methane in the third compartment.

Aspect 28. The methane-oxygen battery system of aspect 26 or 27, wherein the closed system has a constant volume.

Aspect 29. The methane-oxygen battery system of any of aspects 26 to 28, wherein the reactor is a steam reforming reactor configured to convert methane and water to carbon monoxide and hydrogen, and to convert carbon monoxide and hydrogen to carbon dioxide and water.

Aspect 30. The methane-oxygen battery system of any of aspects 26 to 29, wherein the reactor is configured to convert methane and water to carbon monoxide and hydrogen on discharge; and configured to convert carbon monoxide and hydrogen to methane and water on charge.

Aspect 31. The methane-oxygen battery system of any of aspects 26 to 30, wherein the methane-oxygen battery system is configured to passively generate a gas flow between the electrochemical cell and the gas store.

Aspect 32. The methane-oxygen battery system of any of aspects 26 to 31, wherein the (i) the oxygen; (ii) the carbon dioxide and the water; and (iii) the methane are configured to be pressure balanced in the gas store.

Aspect 33. The methane-oxygen battery system of any of aspects 26 to 32, wherein the (i) the oxygen; (ii) the carbon dioxide and the water; and (iii) the methane are configured to have the same pressure in the gas store.

Aspect 34. The methane-oxygen battery system of any of aspects 26 to 33, wherein the first compartment and the second compartment are configured to be pressure balanced, and the second compartment and the third compartment are configured to be pressure balanced.

Aspect 35. The methane-oxygen battery system of any of aspects 26 to 34, wherein the first compartment, the second compartment, the third compartment are configured to have the same pressure.

Aspect 36. The methane-oxygen battery system of any of aspects 26 to 35, wherein the second compartment is in fluid communication with an outlet of the negative electrode of the electrochemical cell, and the third compartment is in fluid communication with an inlet of the negative electrode.

Aspect 37. The methane-oxygen battery system of any of aspects 26 to 36, wherein the first compartment is configured to provide oxygen to the positive electrode on discharge, and is configured to store oxygen on charge, the second compartment is configured to store carbon dioxide and water on discharge, and is configured to provide carbon dioxide and water on charge, and the third compartment is configured to provide methane to the reactor on discharge, and is configured to store methane on charge.

Aspect 38. The methane-oxygen battery system of any of aspects 26 to 37, wherein the first barrier and the second barrier are each independently a movable piston, moveable partition, a flexible diaphragm, an elastic diaphragm, an inflatable bladder, or a combination thereof.

Aspect 39. The methane-oxygen battery system of any of aspects 26 to 38, wherein the electrochemical cell is configured to operate passively, preferably without a pump, a compressor, a blower, or a condenser.

Aspect 40. The methane-oxygen battery system of any of aspects 26 to 39, wherein the electrolyte comprises a solid oxide electrolyte.

Aspect 41. The methane-oxygen battery system of any of aspects 26 to 40, wherein the electrolyte has an oxygen ion conductivity of 0.1 to 100 siemens per meter at 700° C.

Aspect 42. The methane-oxygen battery system of any of aspects 26 to 41, further comprising a heat exchanger configured to exchange heat between the reactor and the electrochemical cell.

Aspect 43. The methane-oxygen battery system of any of aspects 26 to 42, wherein at least one of the reactor and the electrochemical cell are disposed in a thermal chamber.

Aspect 44. The methane-oxygen battery system of any of aspects 26 to 42, wherein the electrochemical cell comprises a plurality of electrochemical cells, wherein at least one electrochemical cell of the plurality of electrochemical cells is in electrical contact with an external circuit.

Aspect 45. The methane-oxygen battery system of aspect 44, wherein at least one electrochemical cell of the plurality of electrochemical cells is a removable electrochemical cell.

Aspect 46. The methane-oxygen battery system of aspect 45, wherein the at least one removable electrochemical cell is configured to be selectively isolated from the methane-oxygen battery system.

Aspect 47. The methane-oxygen battery system of aspect 44 or 45, wherein the at least one removable electrochemical cell is configured to be selectively isolated from the gas store.

Aspect 48. The methane-oxygen battery system of any of aspects 44 to 47, wherein the methane-oxygen battery system is configured to operate when the at least one removable electrochemical cell is isolated from the system and at least one electrochemical cell is not isolated from the system.

Aspect 49. The methane-oxygen battery system of any of aspects 26 to 48, further comprising a processor configured to receive information relating to the position of the first barrier and/or the second barrier, and to determine the state of charge based on the position of the first barrier and/or the second barrier.

Aspect 50. The methane-oxygen battery system of any of aspects 26 to 49, wherein the reactor is: disposed within a negative electrode compartment also comprising the negative electrode of the electrochemical cell; disposed in a separate compartment which is in fluid communication with the negative electrode and separated from the electrochemical cell; or disposed in an interconnect, wherein the electrochemical cell comprises a plurality of electrochemical cells that are connected via the interconnect.

Aspect 51. A methane-oxygen battery system, comprising: an electrochemical cell comprising a positive electrode, a negative electrode, and an electrolyte between the positive electrode and the negative electrode; a reactor in fluid communication with the negative electrode; a fuel gauge configured to determine a state of charge; a gas inlet in fluid communication with the positive electrode and configured to provide oxygen on discharge of the system, a fuel inlet in fluid communication with the negative electrode or the reactor and configured to provide methane on discharge of the system, and an exhaust gas outlet in fluid communication with the negative electrode and configured to exhaust carbon dioxide and water on discharge of the system.

Aspect 52. The methane-oxygen battery system of aspect 51, wherein on charge of the system the gas inlet is configured to exhaust oxygen, the fuel inlet is configured to exhaust methane, and the exhaust gas outlet is configured to provide carbon dioxide and water.

Aspect 53. The methane-oxygen battery system of aspect 51 or 52, wherein the fuel gauge is configured to determine the state of charge based on an amount of the oxygen, the methane, the carbon dioxide and the water, or a combination thereof passing through the system.

Aspect 54. The methane-oxygen battery system of aspect 51, wherein the fuel gauge comprises a plurality of fuel gauges, wherein the plurality of fuel gauges comprises a combination of two or more of (i) a first fuel gauge configured to determine a state of charge based on a mass of oxygen in the first compartment, (ii) a second fuel gauge configured to determine a state of charged based on a mass of carbon dioxide and water in the second compartment, and (iii) a third fuel gauge configured to determine a state of charge based on a mass of methane in the third compartment.

Aspect 55. The methane-oxygen battery system of any of aspects 51 to 54, wherein the reactor is a steam reforming reactor configured to convert methane and water to carbon monoxide and hydrogen, and to convert carbon monoxide and hydrogen to carbon dioxide and water.

Aspect 56. The methane-oxygen battery system of any of aspects 51 to 55, wherein the reactor is configured to convert methane and water to carbon monoxide and hydrogen on discharge; and configured to convert carbon monoxide and hydrogen to methane and water on charge.

Aspect 57. The methane-oxygen battery system of any of aspects 51 to 56, wherein the methane-oxygen battery system is configured to actively generate a gas flow between the electrochemical cell and the gas store.

Aspect 58. The methane-oxygen battery system of any of aspects 51 to 57, wherein the electrochemical cell is configured to operate actively with a pump, a compressor, a blower, a condenser, or a combination thereof.

Aspect 59. The methane-oxygen battery system of any of aspects 51 to 58, wherein the electrolyte comprises a solid oxide electrolyte.

Aspect 60. The methane-oxygen battery system of any of aspects 51 to 59, wherein the electrolyte has an oxygen ion conductivity of 0.1 to 100 siemens per meter at 700° C.

Aspect 61. The methane-oxygen battery system of any of aspects 51 to 60, further comprising a heat exchanger configured to exchange heat between the reactor and the electrochemical cell.

Aspect 62. The methane-oxygen battery system of any of aspects 51 to 61, wherein at least one of the reactor and the electrochemical cell are disposed in a thermal chamber.

Aspect 63. The methane-oxygen battery system of any of aspects 51 to 62, wherein the electrochemical cell comprises a plurality of electrochemical cells, wherein at least one electrochemical cell of the plurality of electrochemical cells is in electrical contact with an external circuit.

Aspect 64. The methane-oxygen battery system of aspect 63, wherein at least one electrochemical cell of the plurality of electrochemical cells is a removable electrochemical cell.

Aspect 65. The methane-oxygen battery system of aspect 64, wherein the at least one removable electrochemical cell is configured to be selectively isolated from the methane-oxygen battery system.

Aspect 66. The methane-oxygen battery system of any of aspects 63 to 65, wherein the methane-oxygen battery system is configured to operate when the at least one removable electrochemical cell is isolated from the system and at least one electrochemical cell is not isolated from the system.

Aspect 67. The methane-oxygen battery system of any of aspects 51 to 66, wherein the reactor is: disposed within a negative electrode compartment also comprising the negative electrode of the electrochemical cell; disposed in a separate compartment which is in fluid communication with the negative electrode and separated from the electrochemical cell; or disposed in an interconnect, wherein the electrochemical cell comprises a plurality of electrochemical cells that are connected via the interconnect.

Aspect 68. A battery fuel gauge configured to determine a state of charge of a methane-oxygen battery, wherein the battery fuel gauge comprises a processor configured to receive information relating to a position of a first barrier and/or as second barrier of a gas store and to determine the state of charge based on the position of the first barrier and/or the second barrier; wherein the methane-oxygen battery comprises: an electrochemical cell comprising a positive electrode, a negative electrode, and an electrolyte between the positive electrode and the negative electrode; a reactor in fluid communication with the negative electrode; and the gas store comprising a first compartment in fluid communication with the positive electrode and configured to store oxygen, a second compartment in fluid communication with an outlet of the negative electrode and configured to store carbon dioxide and water, a third compartment in fluid communication with an inlet of the negative electrode and configured to store methane, the first barrier between the first compartment and the second compartment, and the second barrier between the second compartment and the third compartment, wherein the gas store and the electrochemical cell form a closed system.

Aspect 69. A battery fuel gauge configured to determine a state of charge of a methane-oxygen battery, wherein the battery fuel gauge comprises a processor configured to receive information relating to a mass of a gas in a gas store, wherein the mass of the gas in the gas store comprises a mass of oxygen in a first compartment, a mass of carbon dioxide and water in a second compartment, a mass of methane in a third compartment, or a combination thereof, and to determine the state of charge based on the position of the mass of the gas in the gas store; wherein the methane-oxygen battery comprises: an electrochemical cell comprising a positive electrode, a negative electrode, and an electrolyte between the positive electrode and the negative electrode; a reactor in fluid communication with the negative electrode; and the gas store comprising the first compartment in fluid communication with the positive electrode and configured to store oxygen, the second compartment in fluid communication with the negative electrode and configured to store carbon dioxide and water, the third compartment in fluid communication with the negative electrode and configured to store methane, a first barrier between the first compartment and the second compartment, and a second barrier between the second compartment and the third compartment, wherein the gas store and the electrochemical cell form a closed system.

Aspect 70. A method of operating a methane-oxygen battery system, the method comprising: providing the methane-oxygen battery system of any of aspects 1 to 50; supplying electricity, carbon dioxide, and water to the electrochemical cell to charge the battery system, wherein hydrogen and carbon monoxide are converted in the reactor to methane and water, carbon dioxide and water are converted to carbon monoxide, hydrogen, and oxygen by the electrochemical cell, and the carbon dioxide and a portion of the water are provided by the gas store, and oxygen and methane are stored in the gas store; and discharging the methane-oxygen battery system to convert carbon monoxide, hydrogen, and oxygen to carbon dioxide and water, and produce electricity to operate the methane-oxygen battery system, wherein methane and water are converted in the reactor to hydrogen and carbon monoxide, carbon monoxide, hydrogen, and oxygen are converted to carbon dioxide and water by the electrochemical cell, the carbon dioxide and a portion of the water produced by the electrochemical reactor are stored in the gas store, and the methane is provided by the gas store.

Aspect 71. The method of aspect 70, further comprising determining the state of charge of the methane-oxygen battery system using the fuel gauge or a plurality of fuel gauges.

Aspect 72. A method of operating a methane-oxygen battery system, the method comprising: providing the methane-oxygen battery system of any of aspects 51 to 67; supplying electricity, carbon dioxide, and water to the electrochemical cell to charge the battery system, wherein the carbon dioxide and a portion of the water are provided by the exhaust gas outlet, the carbon dioxide and the water are converted to carbon monoxide, hydrogen, and oxygen by the electrochemical cell, and the hydrogen and the carbon monoxide are converted to methane and water by the reactor; and discharging the methane-oxygen battery system to convert carbon monoxide, hydrogen, and oxygen to carbon dioxide and water, and produce electricity to operate the methane-oxygen battery, wherein the methane is provided by the fuel inlet, the oxygen is provided by the gas inlet, the methane and the water are converted to hydrogen and carbon monoxide by the reactor, the carbon monoxide, the hydrogen, and the oxygen are converted to carbon dioxide and water by the electrochemical cell, and the carbon dioxide and a portion of the water produced by the electrochemical reactor are exhausted by the exhaust gas outlet.

Aspect 73. The method of aspect 72, further comprising determining the state of charge of the methane-oxygen battery system using the fuel gauge or a plurality of fuel gauges.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments,” “an embodiment,” “an aspect,” and so forth, means that a particular element described in connection with the embodiment and/or aspect is included in at least one embodiment and/or aspect described herein, and may or may not be present in other embodiments and/or aspects. In addition, it is to be understood that the described elements may be combined in any suitable manner in the various embodiments and/or aspects. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A methane-oxygen battery system, comprising:
an electrochemical cell comprising
a positive electrode,
a negative electrode, and
an electrolyte between the positive electrode and the negative electrode;
a reactor in fluid communication with the negative electrode;
a fuel gauge; and
a gas store comprising
a first compartment in fluid communication with the positive electrode and configured to store oxygen,
a second compartment in fluid communication with the negative electrode and configured to store carbon dioxide and water,
a third compartment in fluid communication with the negative electrode or the reactor and configured to store methane,
a first barrier between the first compartment and the second compartment, and
a second barrier between the second compartment and the third compartment,
wherein the gas store and the electrochemical cell form a closed system; and
wherein the fuel gauge is configured to determine a state of charge based on a position of at least one of the first barrier or the second barrier.

2. The methane-oxygen battery system of claim 1, wherein the closed system has a constant volume;
wherein the reactor is a steam reforming reactor configured to convert methane and water to carbon monoxide and hydrogen, and to convert carbon monoxide and hydrogen to carbon dioxide and water;
wherein the first barrier and the second barrier are each independently a movable piston, moveable partition, a flexible diaphragm, an elastic diaphragm, an inflatable bladder, or a combination thereof,
wherein the methane-oxygen battery system is configured to passively generate a gas flow between the electrochemical cell and the gas store;
wherein the electrochemical cell is configured to operate passively;
wherein the electrolyte comprises a solid oxide electrolyte;
wherein the electrolyte has an oxygen ion conductivity of 0.1 to 100 siemens per meter at 700° C.;
wherein at least one of the reactor and the electrochemical cell are disposed in a thermal chamber; or
a combination thereof.

3. The methane-oxygen battery system of claim 1, wherein the reactor is
configured to convert methane and water to carbon monoxide and hydrogen on discharge; and
configured to convert carbon monoxide and hydrogen to methane and water on charge.

4. The methane-oxygen battery system of claim 1, wherein the (i) the oxygen; (ii) the carbon dioxide and the water; and (iii) the methane are configured to be pressure balanced in the gas store.

5. The methane-oxygen battery system of claim 1, wherein the (i) the oxygen; (ii) the carbon dioxide and the water; and (iii) the methane are configured to have a same pressure in the gas store.

6. The methane-oxygen battery system of claim 1, wherein the first compartment and the second compartment are configured to be pressure balanced, and the second compartment and the third compartment are configured to be pressure balanced.

7. The methane-oxygen battery system of claim 1, wherein the first compartment, the second compartment, the third compartment are configured to have the same pressure.

8. The methane-oxygen battery system of claim 1, wherein
the second compartment is in fluid communication with an outlet of the negative electrode of the electrochemical cell, and
the third compartment is in fluid communication with an inlet of the negative electrode.

9. The methane-oxygen battery system of claim 1, wherein
the first compartment is configured to provide oxygen to the positive electrode on discharge, and is configured to store oxygen on charge,
the second compartment is configured to store carbon dioxide and water on discharge, and is configured to provide carbon dioxide and water on charge, and
the third compartment is configured to provide methane to the reactor on discharge, and is configured to store methane on charge.

10. The methane-oxygen battery system of claim 1, further comprising a heat exchanger configured to exchange heat between the reactor and the electrochemical cell.

11. The methane-oxygen battery system of claim 1, wherein the electrochemical cell comprises a plurality of electrochemical cells, wherein at least one electrochemical cell of the plurality of electrochemical cells is in electrical contact with an external circuit.

12. The methane-oxygen battery system of claim 11, wherein at least one electrochemical cell of the plurality of electrochemical cells is a removable electrochemical cell.

13. The methane-oxygen battery system of claim 12, wherein the at least one removable electrochemical cell is configured to be selectively isolated from the methane-oxygen battery system.

14. The methane-oxygen battery system of claim 12, wherein the at least one removable electrochemical cell is configured to be selectively isolated from the gas store.

15. The methane-oxygen battery system of claim 12, wherein the methane-oxygen battery system is configured to operate when the at least one removable electrochemical cell is isolated from the system and at least one electrochemical cell is not isolated from the system.

16. The methane-oxygen battery system of claim 1, further comprising a processor configured to receive information relating to the position of the first barrier and/or the second barrier, and to determine the state of charge based on the position of the first barrier and/or the second barrier.

17. The methane-oxygen battery system of claim 1, further comprising a second fuel gauge configured to determine a state of charge based on a mass of a gas in the gas store,
wherein the mass of the gas in the gas store comprises a mass of oxygen in the first compartment, a mass of carbon dioxide and water in the second compartment, a mass of methane in the third compartment, or a combination thereof.

18. A battery fuel gauge configured to determine a state of charge of a methane-oxygen battery,
wherein the battery fuel gauge comprises (i) a processor configured to receive information relating to a position of a first barrier and/or a position of a second barrier of a gas store and to determine the state of charge based on the position of the first barrier and/or the position of the second barrier or (ii) a processor configured to receive information relating to a mass of a gas in a gas store, wherein the mass of the gas in the gas store comprises a mass of oxygen in a first compartment, a mass of carbon dioxide and water in a second compartment, a mass of methane in a third compartment, or a combination thereof, and to determine the state of charge based on the mass of the gas in the gas store;
wherein the methane-oxygen battery comprises:
an electrochemical cell comprising
a positive electrode,
a negative electrode, and
an electrolyte between the positive electrode and the negative electrode;
a reactor in fluid communication with the negative electrode; and
the gas store comprising
a first compartment in fluid communication with the positive electrode and configured to store oxygen,
a second compartment in fluid communication with an outlet of the negative electrode and configured to store carbon dioxide and water,
a third compartment in fluid communication with an inlet of the negative electrode and configured to store methane,
the first barrier between the first compartment and the second compartment, and
the second barrier between the second compartment and the third compartment,
wherein the gas store and the electrochemical cell form a closed system.

19. A method of operating a methane-oxygen battery system, the method comprising:
providing the methane-oxygen battery system of claim 1;
supplying electricity, carbon dioxide, and water to the electrochemical cell to charge the battery system, wherein
hydrogen and carbon monoxide are converted in the reactor to methane and water,
carbon dioxide and water are converted to carbon monoxide, hydrogen, and oxygen by the electrochemical cell, and
the carbon dioxide and a portion of the water are provided by the gas store, and
oxygen and methane are stored in the gas store; and
discharging the methane-oxygen battery system to convert carbon monoxide, hydrogen, and oxygen to carbon dioxide and water, and produce electricity to operate the methane-oxygen battery system, wherein
methane and water are converted in the reactor to hydrogen and carbon monoxide,
carbon monoxide, hydrogen, and oxygen are converted to carbon dioxide and water by the electrochemical cell,
the carbon dioxide and a portion of the water produced by the electrochemical reactor are stored in the gas store, and
the methane is provided by the gas store.

20. The method of claim 19, further comprising determining the state of charge of the methane-oxygen battery system using the fuel gauge or a plurality of fuel gauges.
